(19) United States
(12) Patent Application Publication
(10) Pub. No.: US 2025/0383214 A1
(43) Pub. Date: Dec. 18, 2025

(54) PROGRESS ANOMALY DETECTION

(71) Applicant: Uber Technologies, Inc, San Francisco, CA (US)

(72) Inventors: Karapet Shaginyan, San Francisco, CA (US); Karamveer Choudhary, San Francisco, CA (US); Sebastian Alejandro Marquez Lutfy, San Francisco, CA (US); Yushui Du, Redwood City, CA (US)

(21) Appl. No.: 18/743,356

(22) Filed: Jun. 14, 2024

(51) Int. Cl. G01C 21/36

(52) U.S. Cl. CPC G01C 21/3691

(57) ABSTRACT

This disclosure presents a system for monitoring trips by detecting one or more anomalies for each of a plurality of trips. The system updates route data and utilizes anomaly detectors to identify one or more anomalies, such as detours, low-speed movement, and unexpected stops. The system generates a health status of the trip based on any identified anomalies. In one example, the system disseminates the health status to relevant entities.

### BACKGROUND

Transportation and logistics platforms facilitate the movement of goods and people. Satellite navigation enables these platforms to track vehicles and various devices in addition to providing navigation services, thereby significantly enhancing operational efficiency.

In recent years, the development of transportation and logistics platforms has further transformed the landscape of transportation and delivery services. These platforms serve as a nexus, connecting individuals in need of transportation with a network of vehicle operators. They have redefined traditional taxi services by offering an interface for booking and managing rides. The scope of these platforms has extended beyond passenger transport to include food delivery services, which pair consumers with local eateries and delivery personnel, as well as freight and shipping services that link shippers with carriers. Moreover, these platforms are at the forefront of promoting new mobility solutions, such as electric bikes and scooters, which cater to the evolving needs of urban transportation.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a diagrammatic representation of a mobility network servers 102, operating within a networked environment 100, according to some examples.

FIG. 2 is a system architecture diagram illustrating a progress detection and health assessment platform, according to some examples.

FIG. 3 is a flowchart illustrating a method 300 for anomaly detection during trips, according to some examples.

FIG. 4 is a flowchart illustrating a method 400 for detecting a detour anomaly, according to some examples.

FIG. 5 is a flowchart illustrating a method 500 for detecting a detour anomaly based on distance metrics, according to some examples.

FIG. 6 is a flowchart illustrating a method 600 for determining detour anomaly recovery, according to some examples.

FIG. 7 is a flowchart illustrating a method 700 for determining detour anomaly recovery, according to some examples.

FIG. 8 is a flowchart illustrating a method 800 for detecting a location update anomaly, according to some examples.

FIG. 9 is a flowchart illustrating a method 900 for detecting a GPS anomaly, according to some examples.

FIG. 10 is a flowchart illustrating a method 1000 for detecting a low-speed anomaly, according to some examples.

FIG. 11 is a flowchart illustrating a method 1100 for detecting a stop anomaly, according to some examples.

FIG. 12 is a diagrammatic representation of a machine in the form of a computer system within which a set of instructions can be executed for causing the machine to perform any one or more of the methodologies discussed herein, according to some examples.

### DETAILED DESCRIPTION

In the realm of transportation services, tracking the progress of supply agents, such as drivers and couriers, as well as service consumers, is beneficial for efficient operations in a transportation service network. Traditional systems often operate in silos, using separate components to monitor movements, leading to duplicated efforts and less accurate results due to limited data access. This fragmentation presents a problem as it fails to provide a precise and unified assessment of a trip's progress. There is a need to provide a centralized system that can aggregate multiple data sources, offering a cohesive evaluation of the trip's health status. Such a system would not only reduce redundant work but also enhance the accuracy of progress assessments across the transportation service network.

Systems and methods herein describe a computing system that performs comprehensive progress tracking and proactive management of anomalies. The computing system receives, from multiple data sources, real-time data updates on locations and factors affecting travel, such as traffic and road closures. The computing system employs a set of specialized anomaly detectors to identify anomalies such as deviations from routes, slow speeds, and unexpected stops and to update the trip's health status accordingly. The computing system manages logistics in a way that ensures timely progress and quick responses to disruptions, significantly improving the reliability and oversight of transportation services. The computing system's unified output of health status streamlines communication within the transportation service network, allowing various internal and external systems to access and utilize the health status, thereby maintaining operational consistency and efficiency.

The computer system performs methods to facilitate progress tracking and logistical oversight. One example method comprises the following steps: receiving, in real-time, Global Positioning System (GPS) data from a plurality of devices, each device corresponding to a supply agent executing a respective route for a respective trip; analyzing, by each anomaly detector of a set of anomaly detectors, the received GPS data to generate an output associated with a respective anomaly detector and the respective trip; generating an updated health status for each trip using the output from each anomaly detector; determining that the updated health status for a first trip triggers a notification; and providing the notification associated with the updated health status for the first trip. In an embodiment, a computing apparatus comprising a processor and memory storing instructions that, when executed, configure the apparatus to perform these steps. In another embodiment, a non-transitory computer-readable storage medium containing instructions that, when executed by a computer, causes the computer to perform these steps.

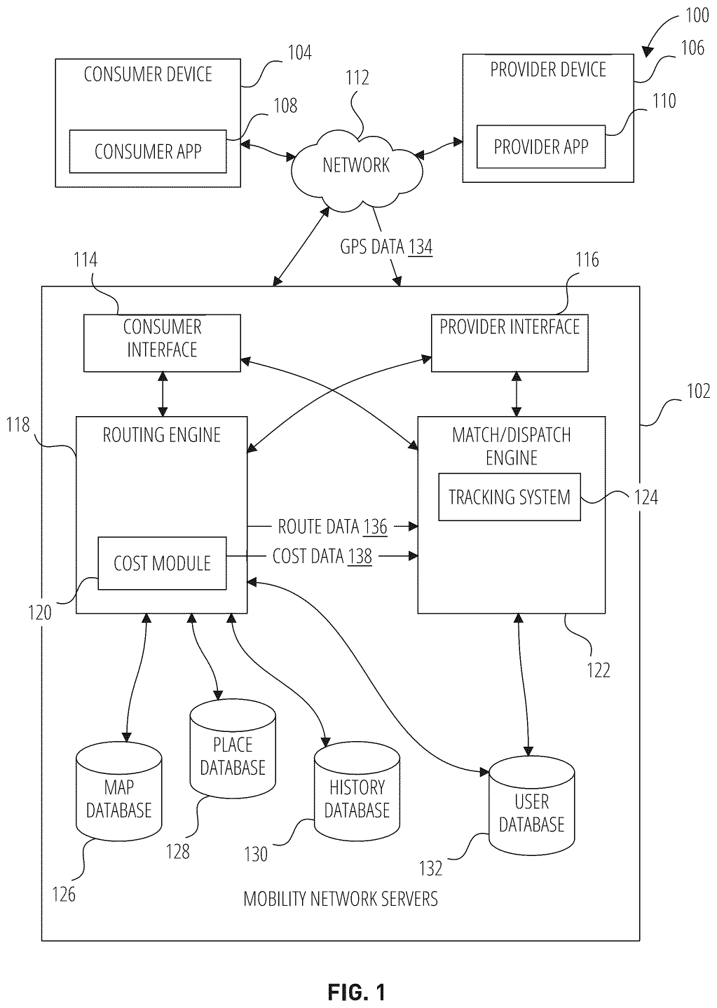

FIG. 1 is a diagrammatic representation of a mobility network servers 102, operating within a networked environment 100, according to some examples. The mobility network servers 102 operatively facilitates delivery of a service by a supply agent to a service consumer. In some examples, the mobility network servers 102 is dedicated to a particular vertical and focus on the delivery of a single service (e.g., a transportation service for the transportation of either persons or goods). In other examples, the mobility network servers 102 operate to enable the delivery of services across a range of different verticals and service types. A supply agent can be a human supply agent, a fully automated supply agent, or a combination thereof. For example, where the supply agent performs a transportation service, the supply agent can be a human or a robot operating a transportation vehicle, such as an automobile or aircraft, a fully autonomous vehicle, or a combination of human-piloted and autonomous vehicles deployed to deliver the transportation service. In another example, the supply agent itself can be an autonomous vehicle or a robot performing transportation services or delivery services.

FIG. 1 shows the mobility network servers 102 to be communicatively coupled via a network 112 to both a consumer device 104 and a provider device 106. The consumer device 104 hosts and executes a consumer application 108, while the provider device 106 hosts and executes a provider application 110. In some examples, the consumer device 104 is a mobile computing device (e.g., a mobile telephone), executing a consumer application 108 downloaded from an appropriate app store (e.g., the Uber application that executes on either iOS or the Android operating systems). Similarly, the provider device 106 can be a mobile computing device, and the provider application 110 can be an application designed to run on a mobile operating system (e.g., iOS or Android operating systems). The mobility network servers 102 can also interface with other types of devices, such as desktop computers, third-party service systems, and cloud-based computing systems.

The mobility network servers 102 includes a consumer interface 114 (e.g., an appropriate set of Application Program Interfaces (APIs)) for facilitating communications, via the network 112, with the consumer device 104. Similarly, a provider interface 116 (e.g., again, a suitable set of APIs) facilitates communications between the mobility network servers 102 and the provider device 106.

In some examples, the consumer interface 114 and the provider interface 116 comprise APIs, these APIs can facilitate interactions between the mobility network servers 102 and third-party applications hosted on various devices. For example, where the mobility network servers 102 is a transportation service system, third-party applications can include widgets or buttons that enable a user to specify and deliver a service request from the third-party application to the transportation service.

The consumer interface 114 is communicatively coupled, and provides interactive access, to both a routing engine 118 and a match/dispatch engine 122 of the mobility network servers 102. Similarly, the provider interface 116 is communicatively coupled, and provides interactive access, to both the routing engine 118 and the match/dispatch engine 122.

At a high level, the routing engine 118 operatively generates route data 136 to facilitate the provision of services from a supply agent to a service consumer. For example, the routing engine 118 generates route data 136 to route a supply agent to a location at which a service consumer is located. Similarly, the routing engine 118 generates route data 136 to a service consumer to route a service consumer to a location at which the supply agent is located. Further, where the service is a transportation service (e.g., of a person or a good), the routing engine 118 generates route data 136 to assist the supply agent in delivering the transportation service. In some examples, route data 136 include one or more segments (e.g., checkpoints).

In order to generate the route data 136, the routing engine 118 receives Global Positioning System (GPS) data 134 from either the consumer device 104 and/or provider device 106, and the routing engine 118 has access to a map database 126, a place database 128, a history database 130, and a user database 132.

In some examples, GPS data 134 include geographic location (e.g., location coordinates) of consumer device 104 and/or provider device 106, GPS update rates, which indicate the frequency of location information updates; GPS horizontal accuracies, which measure the precision of the location data; signal strength, which reflects the quality of the GPS signal received; and other relevant metrics. Note that the term “GPS” refers to any satellite-based navigation system that provides geo-spatial positioning services such as Galileo, BeiDou, GLONASS, and others. In some examples, the GPS data 134 is obtained through GPS hardware embedded within the consumer device 104 and/or the provider device 106. The GPS hardware receives signals from satellites, which allows the GPS hardware of the consumer device 104 and/or the provider device 106 to communicate GPS data 134 with the mobility network servers 102.

The map database 126 contains records for transportation infrastructure (e.g., data reflecting a air, road network, rail network, or other transportation route network). In some examples, the map database 126 includes OpenStreetMap (OSM) data or other proprietary road network data. In one example, the routing engine 118 includes an Open Source Routing Machine (OSRM) engine or any one of several other proprietary routing engines.

The map database 126 stores map data according to various formats and standards, such as the road or route map data roads and transport links formatted as an OSM file. The map data can conform to topological data structures and include multiple types of map data primitives, such as segments, nodes, ways, and relationships. Furthermore, the map database 126 can store Open cyclist Map (OCM) data, this data complying with a map format developed for cyclists and used by OSM. These maps include key information for cyclists, such as national, regional, and local roads, as well as cycle paths and footpaths. Records within the map database 126 can be formatted as OSM files, or as shapefiles, which is a format used for storing vector geographic data. Further, the data within the map database 126 can use a topological data structure (e.g., when formatted as an OSM file), with multiple core elements or data primitives. Specifically, these data elements include nodes (points with a geographic location, stored as latitude and longitude coordinates), ways (ordered list of nodes representing a polyline or possibly a polygon), relations (ordered lists of nodes, ways and relations, where each member can have a “role”), and tags (key-value pairs used to store metadata about map objects). Other examples of map data include HERE TECHNOLOGIES map data (Nokia), TELE ATLAS map data (TomTom), or GOOGLE MAP data.

The place database 128 includes place data in the form of records for various places and locations, these records being used to supplement the map data from the map database 126 when generating the route data 136. Specifically, a place record within the place database 128 includes multiple names or other identifiers for specific locations (e.g., a restaurant or a shop), as well as latitude and longitude information. This place data can be used to more accurately identify a location specified in a request received from either a service consumer or provider.

The history database 130 stores historical information regarding past trips (e.g., GPS trace routes, logs and reroute incidents). This historical information is used by the routing engine 118 in order to generate cost data 138. For example, historical data within the history database 130 can be used by the routing engine 118 to modify or adjust cost data 138, based on historical traffic patterns within segments of a particular route.

The routing engine 118 further includes a cost module 120 that generates cost data 138. Cost data 138 are associated with one or more segments of the route data 136. Cost data 138 can include remaining times, and/or remaining distances associated with different route segments, routes, waypoints, target locations, or destinations. A remaining time is an estimate of the anticipated duration required to reach a target location from a current location. A remaining distance is a distance between a current location to a target location. Cost data 138 can also include time cost(s) and distance cost(s) associated with the one or more segments of the route. In some examples, time cost(s) represent estimated time required for a supply agent to finish one or more segments of the route, while distance cost(s) represent the distance(s) of these one or more segments of the route.

In other words, cost data 138 can include the estimated time left (e.g., remaining time) for a supply agent, such as a driver, a delivery person, or an autonomous vehicle, to complete different segments of their route from his/her/its current location. For instance, the cost module 120 estimates that it will take 5 minutes for the supply agent to travel from point A to point B, which is a segment of the overall route, and then an additional 8 minutes to go from point B to point C, which is another segment of the route. Additionally, cost data 138 include the estimated remaining distance(s) that need to be covered in one or more segments of the route. For example, the cost module 120 determines that the distance cost from point A to point B is 1 mile, and the distance cost from point B to point C is 600 feet.

In some examples, time cost and distance cost refer to the estimated duration and distance for a supply agent to travel from a starting location (e.g., the beginning of a segment) to a target location (e.g., the end of the segment). Conversely, a remaining time and a remaining distance are dynamic, real-time calculations of the time and distance left for a supply agent to reach the target location once en route. In some examples, time cost and remaining time are used interchangeably, and distance cost and the remaining distance are used interchangeably.

Cost data 138 can also relate to an estimated time of arrival (ETA) of a supply agent at a service consumer (e.g., a driver at a pickup location for a passenger), the ETA of a service consumer at a location of a supply agent (e.g., where a service consumer travels to a supply agent's location for either pickup or delivery of the service), or an ETA for the destination arrival for the transportation service (e.g., the drop off of a passenger or delivery of a cargo).

In some examples, the cost module 120 generates cost data 138 associated with the one or more segments of the route based on GPS data 134 (e.g., geographic location), information and data stored in the map database 126, place database 128, history database 130, and/or user database 132.

The routing engine 118 deploys a number of segment cost models (e.g., within cost module 120), algorithms, and data processing techniques in order to generate route data 136. In one example, the routing engine 118 uses an informed search algorithm, such as A*, to perform low-cost pathfinding and graph traversal by attributing costs (e.g., cost data 138) of paths or segments between nodes on a graph map (e.g., generated from the map database 126 and the place database 128). The routing engine 118 uses dynamic contraction hierarchies as part of a routing algorithm. Sharding (e.g., breaking up graphs into geographic regions) can be used to improve the performance, while the A* or Dijkstra's search algorithm with heuristics, can be used to prioritize nodes in a graph map to generate the route data 136.

The routing engine 118, as will be described in further detail below, can also attribute different costs to one or more segments (or adjust the cost data 138 associated with the one or more segments), based on various observed (e.g., in near real-time) or known characteristics of an area or region to be traversed (e.g., weather conditions or the grade or surface condition of a road), GPS data 134 (e.g., geographic locations), and/or a vehicle (e.g., automobiles, bicycles, aerial vehicle fleet, scooters).

The match/dispatch engine 122, in some examples, operates as a dispatch system. Specifically, the match/dispatch engine 122 operatively matches a service request, received from a consumer device 104 with an available supply agent. When operating as a dispatch system, the match/dispatch engine 122 matches a particular service consumer with a particular supply agent based on a number of factors, such as the geographic proximity of the respective parties and the current or future availability of the relevant supply agent. To this end, the match/dispatch engine 122 accesses tracking system 124, which receives GPS data 134 from either the consumer device 104 and/or provider device 106 regarding geographic locations of a supply agent as well as a service consumer.

The tracking system 124 actively communicates geographic location regarding either a consumer device 104 and/or a provider device 106 to the cost module 120, both prior to and during a service delivery operation, to enable cost module 120 to dynamically update cost data 138.

To perform service matching operations, the match/dispatch engine 122 is communicatively coupled to, and has access to, the user database 132. The user database 132 maintains user records for both supply agents and service consumers. The routing engine 118 likewise has access to the user database 132 and, as will be described in further detail herein, uses user profile information maintained within the user database 132, to personalize the route data 136 for either a service consumer or a supply agent.

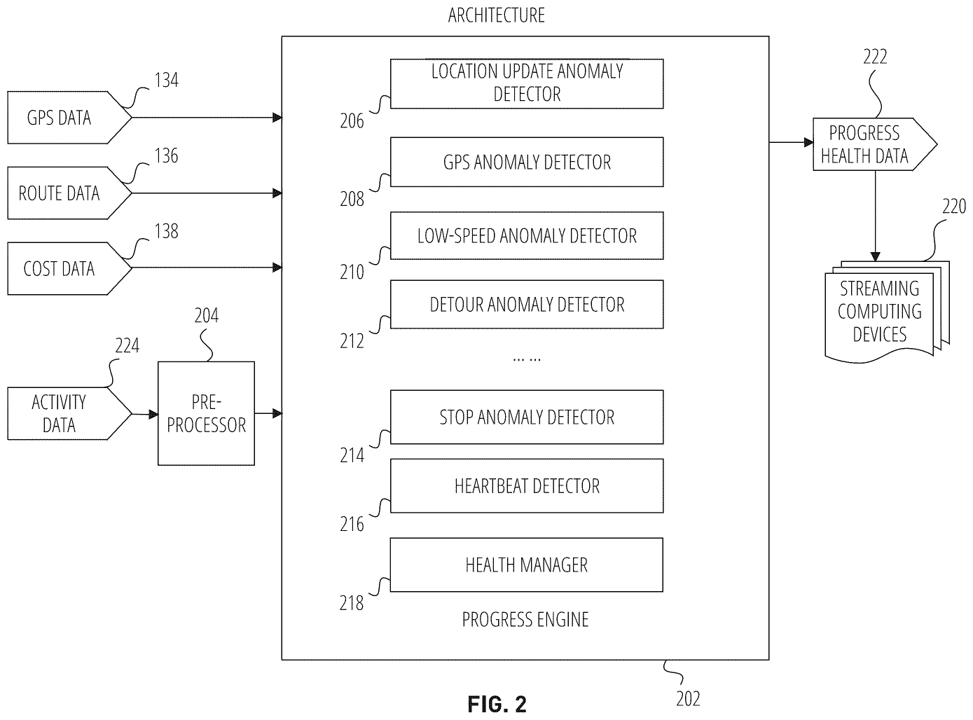

FIG. 2 is a system architecture diagram illustrating a progress detection and health assessment platform including a progress engine 202, according to some examples. In some examples, the progress engine 202 is hosted on a cloud computing system as a FaaS (Function as a Service), which is tasked with the continuous monitoring and evaluation of supply agents' statuses within a mobility network and dynamically manages the allocation of resources, ensuring efficient operation under varying loads. The progress engine 202 can be integrated into the mobility network servers 102, functioning as a part of, or in conjunction with, the routing engine 118. The progress engine 202 provides information related to each trip based on the outputs of various anomaly detectors.

The progress engine 202 is both scalable and event-driven, capable of responding to real-time events and scaling resources up or down as needed to handle varying workloads. In some examples, a server-less architecture allows the progress engine 202 to operate without reliance on dedicated, persistent server infrastructure. Instead, the progress engine 202 dynamically allocates computational resources on demand, thereby optimizing efficiency and reducing operational costs.

GPS data 134 from consumer device 104 and/or provider device 106, route data 136, and activity data 224 is input to and received at the progress engine 202. GPS data 134 can include location coordinates and/or geographic locations of consumer devices 104 and/or provider devices 106 and timestamps associated with each geographic location. GPS data 134 can further include GPS update rates, which indicate the frequency of location information updates and GPS horizontal accuracies, which measure the precision of the location data. The GPS data 134 can further include signal strength, which reflects the quality of the GPS signal received, and other relevant information that allows the progress engine 202 to track the movement and progress of each supply agent and/or service consumer.

Route data 136 encompasses a wide array of information pertaining to the planned routes of supply agents and service consumers. This route data 136 can include, but is not limited to, waypoints, estimated times of arrival (ETAs), and distance metrics of a supply agent's or a service consumer's trip. Waypoints are geographic locations, defined by location coordinates, that are used to mark points along a route. In some examples, route data 136 is derived from a routing engine 118 that calculates optimal paths based on various criteria such as traffic conditions, road closures, and historical travel patterns.

Activity data 224 captures the behavioral patterns of supply agents and service consumers, such as their movement modality (e.g., driving, walking, running, idling, bicycle), and are inputted to and received at an activity recognition pre-processor 204 of the progress engine 202. The activity data 224 is sourced from sensors or applications running on consumer devices 104 and provider devices 106. In some examples, the activity recognition pre-processor 204 processes the activity data 224 and generates probabilistic assessments of the activity states. In some examples, after being processed by the activity recognition pre-processor 204, the activity data 224 comprises probabilities associated with different movement modalities. For example, the activity data 224 includes information comprising a supply agent has 10% chance of being idle, 80% chance of walking, and 10% chance of running. Activity data 224 is analyzed to determine the service consumer's and/or supply agent's operational status. In some examples, activity data 224 is used to infer potential deviations from expected behavior patterns and/or to cause various anomaly detectors to adjust one or more threshold values (e.g., predetermined speed, predetermined distance) due to different expectations associated with different movement modalities.

The activity recognition pre-processor 204 functions as a data refinement module, transforming raw activity data 224 into a structured and standardized format for subsequent analysis by the anomaly detectors. This component employs various data processing techniques, such as filtering, noise reduction, and temporal alignment, to ensure the integrity and usability of the activity data. In some examples, activity recognition pre-processor 204 also enriches the data by adding contextual information or by correlating it with other data sources to enhance the accuracy of activity recognition.

In some examples, the route data 136, GPS data 134, and activity data 224 together form the layers of information upon which the anomaly detection capabilities of the progress engine 202 are built.

The architecture in FIG. 2 comprises a number of anomaly detectors 206-216. A location update anomaly detector 206 is tasked with analyzing route data 136, GPS data 134, and activity data 224 to identify anomalies related to the frequency and quality of location updates. For example, the location update anomaly detector 206 detects a location update anomaly which indicates that the service consumer's and/or supply agent's progress is not accurately known due to insufficient location updates. In some examples, location update anomaly detector 206 discerns patterns indicative of signal loss or degradation.

A GPS anomaly detector 208 examines the precision of GPS data 134 to detect issues that could impact the detection of the service consumer's and/or supply agent's progress. For example, the GPS anomaly detector 208 detects a GPS anomaly based on inaccuracies in GPS data, such as those caused by environmental factors or signal interference.

A low-speed anomaly detector 210 is configured to assess the service consumer's and/or supply agent's travel speed against established speed profiles. The low-speed anomaly detector 210 identifies instances where the service consumer's and/or supply agent's speed is lower than expected, which can indicate congestion or other impediments to normal progress. In some examples, the low-speed anomaly detector 210 compares real-time speed data against historical traffic patterns to ascertain the likelihood of a speed-related anomaly (e.g., low-speed anomaly). In some examples, the low-speed anomaly detector 210 identifies a low-speed anomaly detector 210 based on the activity data 224. For example, in response to detecting that a supply agent is in a first modality (e.g., walking) based on the activity data 224 but the supply agent is expected to be in a second modality (e.g., driving), the detour anomaly detector 212 determines that a stop anomaly has occurred.

A detour anomaly detector 212 monitors the service consumer's and/or supply agent's adherence to one or more assigned routes, utilizing a time budget and distance budget to detect route deviations. The detour anomaly detector 212 leverages the concept of a flexible threshold, allowing for valid detours while identifying inefficient routing choices. In some examples, the detour anomaly detector 212 dynamically adjusts the time budget and distance budget in response to real-time traffic updates or route modifications.

A stop anomaly detector 214 detects instances where the service consumer and/or supply agent has halted progress for an extended duration. The stop anomaly detector 214 identifies unplanned stops that could signal a service disruption or a deliberate pause in movement. In some examples, the stop anomaly detector 214 differentiates between stops made in traffic and natural stops made at locations such as rest areas or service stations based on the information stored in the place database 128 and other data sources.

A heartbeat detector 216 serves as a comprehensive source of information for a trip, comprising details about the route as well as the supply agent and/or service consumer. In some examples, heartbeat detector 216 accesses data from multiple sources, including GPS data 134, route data 136, cost data 138, and activity data 224, along with output from the activity recognition pre-processor 204. The heartbeat detector 216 then synthesizes this data into a stream of ongoing information, which is communicated to the health manager 218. In examples in which anomaly detectors, such as 206, 208, 210, 212, and others, do not report to the health manager 218, such as due to the absence of detected anomalies, the heartbeat detector 216 ensures uninterrupted communication with the health manager 218, allowing the health manager 218 to continuously provide progress health data 222 to downstream streaming computing devices 220.

The health manager 218 is tasked with the integration of outputs from various anomaly detectors (e.g., location update anomaly detector 206, GPS anomaly detector 208, etc.), output of the heartbeat detector 216, and/or various external systems to output progress health data 222 comprising a holistic health state (e.g., health status) for each trip. Each specialized anomaly detector and heartbeat detector 216 feed information related to the trip into health manager 218, providing insights into different facets of the trip. In some examples, the health manager 218 generates progress health data 222 in response to receiving outputs from one or more anomaly detectors and/or the heartbeat detector 216. In other examples, the health manager 218 updates progress health data 222 at a predefined cadence (e.g., every 10 seconds).

In some examples, the health manager 218 also interfaces with external systems or services to provide a comprehensive overview of the service consumer's and/or supply agent's status. In some examples, external systems include traffic data platforms, weather information services, or supply chain management tools. By integrating external data sources, such as real-time traffic conditions, weather conditions, environmental conditions, or social events occurring or planned near the geographic locations of the service consumer and/or supply agents such as concerts or sport events that can impact the service consumer's and/or supply agent's ability to maintain expected progress, the health manager 218 provides a more nuanced and context-aware assessment. This holistic approach ensures that the health status reflects not only the internal data from the vehicle of the supply agent, the provider device 106, and the consumer device 104 but also the external data sources that could influence the trip's outcome.

In some examples, each output from the various anomaly detectors comprises a confidence score reflecting the level of confidence associated with the detected anomaly. The health manager 218 can employ algorithms to weigh the various anomalies based on the confidence scores and determine the health status of the trip. In some other examples, the health manager 218 assigns different levels of significance and/or certainty to the outputs from the various anomaly detectors based on the outputs from the heartbeat detector 216 and other external systems. For example, the health manager 218 assigns a higher confidence score to a low-speed anomaly detected based on corroborative speedometer readings from external systems (e.g., onboard computers of the supply agent or the supply agent's vehicle, onboard computers of an autonomous vehicle). For another example, if external data sources—such as traffic data platforms, navigation supply agents, or external mapping services—alongside the map database 126, provide information that corroborates the existence of traffic congestion, the health manager 218 adjusts the confidence scores attributed to a low-speed anomaly.

In some examples, the health manager 218 determines a health status by utilizing a rule-based procedure to determine the health status of the trip when there are conflicting outputs by the suite of anomaly detectors. For example, consider a scenario where the detour anomaly detector 212 provides an output indicating a detour anomaly exists due to a significant overrun from the time budget, while simultaneously, the low-speed anomaly detector 210 indicates that a low-speed anomaly does not exist because the vehicle's speed is consistent with traffic flow for the current segment of the route. In this situation, the health manager 218 applies a rule-based logic to resolve the conflict. As an example, the health manager 218 can prioritize the detour anomaly due to its potential to cause a longer delay or a more significant deviation from the trip's objectives. Consequently, the health manager 218 would output an “unhealthy” health status to the trip, to trigger intervention or closer monitoring.

In some examples, the progress health data 222 comprises a health status that comprises at least one of the following: healthy, unhealthy, inconclusive, or recovered. A healthy health status indicates that the trip is proceeding as expected without any significant issues or detected anomalies. An unhealthy health status indicates that potential problems and/or anomalies are detected. An inconclusive health status indicates that either the confidence levels related to the inputs are too low, the inputs indicate conflicting outcomes, and/or more data is required to refine the analysis. A recovered health status indicates that one or more previously detected anomalies have been resolved or is no longer affecting the trip's progress.

In some examples, the various anomaly detectors within the progress engine 202, including the location update anomaly detector 206, GPS anomaly detector 208, low-speed anomaly detector 210, detour anomaly detector 212, and stop anomaly detector 214, utilize machine learning models to detect and/or predict anomalies. The machine learning models can be trained using data inputs comprising GPS data 134, Route Data 136, Cost Data 138, activity data 224, and/or other inputs from external systems.

In some examples, the training of each of the machine learning models involves supervised machine learning techniques, where the models are fed historical data with known outcomes (e.g., known anomalies, detected anomalies). These training data allow multi-layered neural networks to learn the correlation between the data inputs and the occurrence of anomalies. For example, the detour anomaly detector 212 can be trained to recognize patterns in changes in cost data that historically led to detecting detour anomalies.

Once the neural networks are trained, they can process new data inputs to predict and/or detect anomalies. These predictions and/or detections are then validated against the outcomes determined using other methods disclosed herein and/or outcomes determined manually. In some examples, health manager 218 confirms the presence of anomalies and provides a feedback loop to refine the neural networks, enhancing their predictive capabilities over time.

The various anomaly detectors can also utilize unsupervised learning techniques in the anomaly detection process. For example, the low-speed anomaly detector 210 and stop anomaly detector 214 utilize unsupervised learning to identify unusual GPS data patterns that indicate a low-speed anomaly and/or a stop anomaly, which have not been previously labeled in the training dataset.

The progress engine 202 can incorporate more anomaly detectors for detecting anomalies that have not been defined/named. For example, the progress engine 202 can utilize unsupervised learning techniques to detect new anomalies that have not been defined previously. The machine learning models can detect outliers and novel patterns in the data inputs to the progress engine 202, flagging them for further investigation and/or marking them as new anomalies. The detections can then be incorporated into the training dataset, enriching the machine-learning process with new instances of anomalies.

The health manager 218 outputs progress health data 222 (e.g., health data), which is a unified output comprising the health status of one or more trips. Progress health data 222 is then disseminated to downstream streaming computing devices 220 and/or archived in storage to create historical health data. Historical health data is used by the progress engine 202 and streaming computing devices 220. Having a unified output stream (e.g., progress health data 222) has several technical benefits. One technical benefit is simplified complexity. For example, the streaming computing devices 220, such as routing engines or customer service platforms, can make informed decisions based on a single status indicator rather than having to interpret multiple, potentially conflicting signals. One technical benefit is enhanced accuracy. For example, the health manager 218's ability to synthesize inputs from multiple anomaly detectors helps to filter out false positives and account for various factors like reasonable stops, resulting in a more accurate representation of the health status of the trip and improving the reliability of the system. One technical benefit is operational efficiency. For example, a unified output streamlines the communication protocol between the health manager 218 and the streaming computing devices 220, enabling faster response times and more efficient data handling. Another technical benefit is allowing for retrospective analysis. For example, archiving the unified output as historical health data allows for retrospective analysis, which can be used to refine machine learning models, improve predictive capabilities, and enhance future trip monitoring. Another technical benefit is consistency. For example, a unified output stream provides a consistent format for health data which ensures that all downstream systems and processes are aligned and is beneficial for maintaining operational consistency across the platform.

Streaming computing devices 220 represent the downstream computing processes or decision-making entity computing systems that utilize the progress health data 222 output by the health manager 218. In some examples, streaming computing devices 220 include routing engine 118, match/dispatch engine 122, customer service platform computing systems, real-time monitoring dashboards, and other components of the mobility network servers 102.

Streaming computing devices 220 can leverage the progress health data 222 to optimize routing decisions, manage service expectations, or initiate corrective actions in response to detected anomalies. In some examples, the routing engine 118 uses the progress health data 222 to improve route planning and avoid areas with frequent anomaly occurrences. The match/dispatch engine 122 can use the progress health data 222 to detect fraudulent activities such as intentionally taking longer routes to induce cancellations by service consumers. The match/dispatch engine 122 ensures that supply agents are complying with regulatory requirements, such as taking mandated rest stops on long trips, based on the progress health data 222. The match/dispatch engine 122 performs trip assignments and/or adjustments based on the progress health data 222. The mobility network servers 102 use the progress health data 222 to incentivize supply agents that consistently make progress on their route efficiently. The mobility network servers 102 dynamically adjust the pricing of the services based on the progress health data 222 updated in real-time. The mobility network servers 102 send alerts or assistance to supply agents who appear to be either off-route, stopped unexpectedly and/or in an emergency situation. The mobility network servers 102 provide real-time updates (e.g., trigger notifications) to service consumers about their services via the consumer application 108 and provide context for delays, such as traffic conditions or necessary detours. The mobility network servers 102 nudge the supply agent and/or service consumer to proceed to his/her/its waypoint. For example, penalizing either the supply agent and/or service consumer for not reaching the planned waypoint within an assigned time period. One of the penalties can be increasing the length of time it takes to match up with a service consumer and/or supply agent.

The mobility network servers 102 monitor the quality of service provided by the supply agent based on the progress health data 222. The mobility network servers 102 update information on different regions and time periods in the map database 126, place database 128, and/or history database 130 based on the progress health data 222. In some examples, streaming computing devices 220 also receive inputs directly from the set of anomaly detectors to perform certain actions that correspond to a detected anomaly. For example, the match/dispatch engine 122 can re-assign a new driver to a trip in response to detecting a stop anomaly in addition to detecting that a supply agent never started the trip.

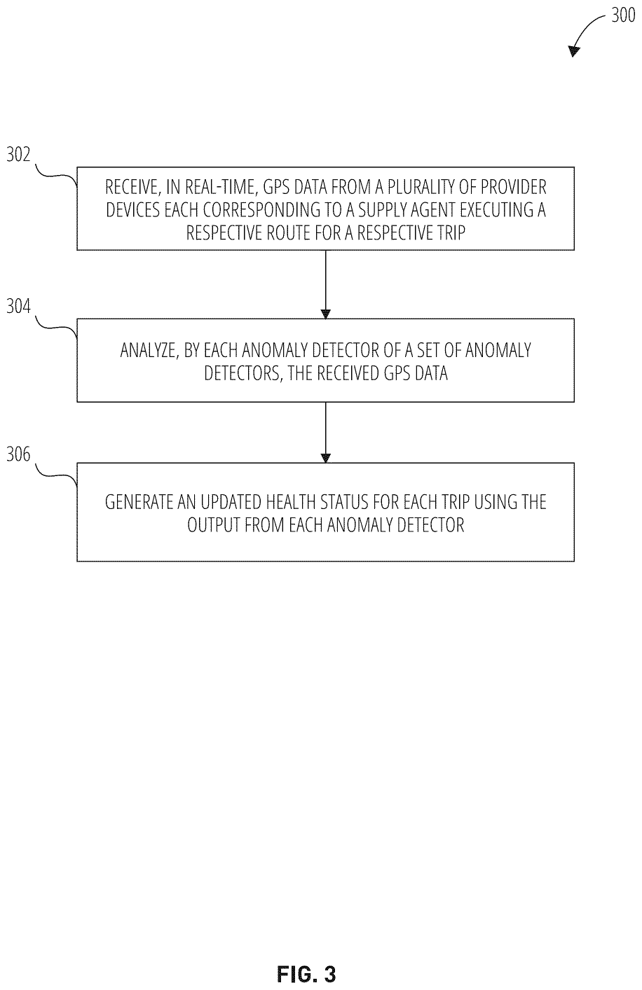

FIG. 3 is a flowchart illustrating a method 300 for anomaly detection during trips, according to some examples. Method 300 is designed to monitor and analyze trips executed by supply agents, such as drivers or couriers, to detect any deviations or anomalies that occur during the course of a trip, and to generate a health status for each trip. Method 300 includes operations that contribute to the anomaly detection and outputting of a health data based on various data inputs and anomaly detectors' outputs.

In operation 302, a computing system (e.g., progress engine 202) receives GPS data 134 transmitted from a plurality of provider devices 106 in real-time. For example, GPS data 134 is received periodically or in real-time/near real-time, such as instantaneously and/or continuously. In some examples, the GPS data 134 is received at regular, predefined intervals (e.g., once every four seconds) that ensure timely updates. In some other examples, the progress engine 202 receives the GPS data 134 as it becomes available, enabling the ability to analyze real-time progress and other metrics of the trips. In some examples, each provider device 106 is associated with a supply agent.

In operation 304, the computing system analyzes, by each anomaly detector of a set of anomaly detectors, the received GPS data. In some examples, the computing system updates cost data 138 associated with each route based on the GPS data 134 received from the provider devices. The updates to the cost data 138 are performed dynamically to reflect real-time conditions and any changes that occur during the trip. Changes due to progress, traffic, detours, or other factors affecting the cost data 138. The computing system utilizes one or more predefined anomaly detectors to identify anomalies associated with each trip. These anomaly detectors are specialized modules within the progress engine 202 that analyze the GPS data 134 and/or the cost data 138 to detect irregularities such as unexpected stops, deviations from the planned route, low speed, or lack of location updates, as explained above. These anomaly detectors will also be discussed in further detail below.

In operation 306, the computing system generates health data for each trip based on any anomalies detected in operation 306. The health data comprises an assessment of the health of the trip (e.g., health status), indicating whether the supply agent is making expected progress, encountering delays, or exhibiting behavior that could indicate a potential issue. The health data can be communicated to other systems or stakeholders, including streaming computing devices 220 such as the match/dispatch engine 122, customer service, and the provider devices 106. These streaming computing devices 220 take appropriate actions based on the health data.

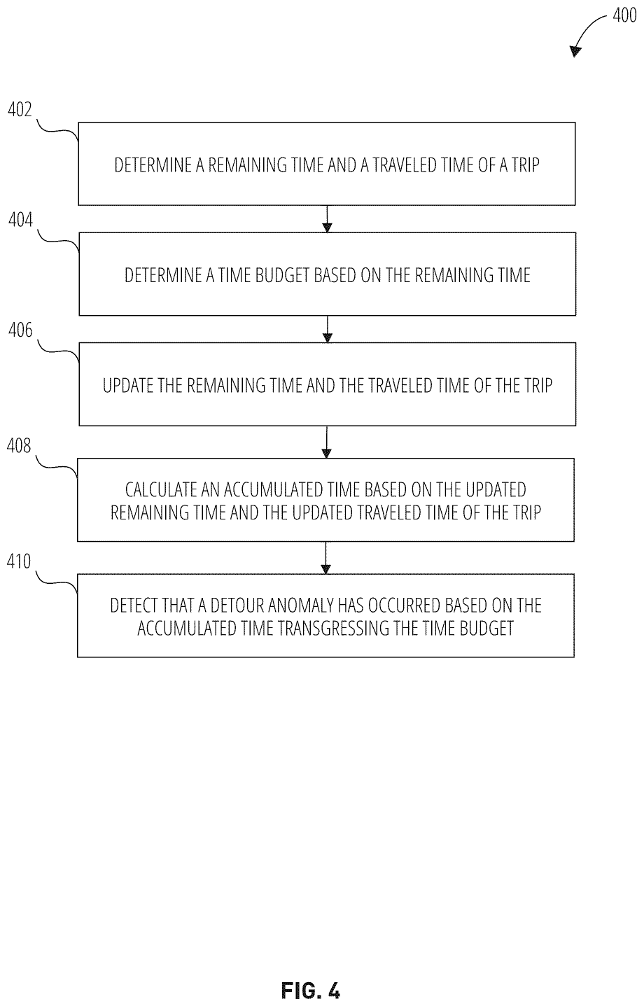

FIG. 4 is a flowchart illustrating a method 400 for detecting a detour anomaly, according to some examples. In some examples, method 400 detects a detour anomaly has occurred based on the newly estimated remaining time to complete one or more segments of a route that is longer than the time that was originally estimated (e.g., time cost).

In operation 402, the computing system (e.g., via detour anomaly detector 212) determines a remaining time and a traveled time of a trip. Cost data 138, shown in FIG. 1, can include the remaining time and traveled time, and is updated in real-time or periodically based on the received GPS data. Traveled time indicates the duration the supply agent has been on the trip since the commencement of the trip (e.g., the time that the supply agent has already incurred on the trip). For example, a route for a trip can include multiple segments. Using a simple example where a route includes two segments: a first segment extends from location A to location B, and a second segment extends from location B to location C wherein a time to cover the first segment (i.e., time cost) is estimated at 30 minutes, and a time to cover the second segment is estimated at 15 minutes. At the start of the trip, when the supply agent is at location A, the time cost for the first segment is 30 minutes, and the time cost for the second segment is 15 minutes. At the commencement of the trip, traveled time is zero. As the trip progresses, a remaining time for the trip is updated in real-time, taking into account the newly received traffic conditions of the current segment, geographic locations of the supply agent, type of transportation being used, and/or other relevant factors.

In operation 404, the computing system sets a time budget based on the remaining time for the trip. The time budget is a duration of time allocated to the supply agent to complete the trip. In some examples, detour anomaly detector 212 determines that the supply agent is on a detour based on predicting that the supply agent will take a longer time to reach the target location than the time left in the time budget. In some examples, the time budget is set to be a percentage longer than the time cost for the trip. For example, if the time budget is 10% longer than the time cost for the trip, a 30-minute time cost would result in a time budget of 33 minutes (30 minutes×110%) for completing the trip. In some examples of method 400, operation 404 for setting a time budget is omitted, and the updated remaining time is directly compared with the remaining portion of the initially calculated time cost (e.g., initially calculated time cost minus the traveled time) to determine whether a detour anomaly has occurred.

In operation 406, the computing system updates the remaining time and the traveled time of the trip as the trip progresses. In some examples, the cost module 120 shown in FIG. 1 updates cost data 138 including the remaining time. The detour anomaly detector 212 accesses the updated remaining time and the updated traveled time of the trip. For example, the supply agent aims to reach target location B from location A. At location A, the time cost to reach location B is estimated to be 30 minutes. When the supply agent reaches a current location, which is in between location A and location B, the detour anomaly detector 212 accesses the updated remaining time and the updated traveled time of the trip. For example, the updated remaining time is 20 minutes and the updated traveled time is 15 minutes.

In operation 408, the computing system calculates an accumulated time based on the updated remaining time and the updated traveled time of the trip. The accumulated time is the sum of the updated remaining time and the updated traveled time, expressed as accumulated time=remaining time+traveled time. Using the example above, the accumulated time would be 35 minutes (20 minutes+15 minutes). Thus, the new estimated time to complete the trip from location A to location B (i.e., the accumulated time) is 35 minutes (i.e., 20 minutes+15 minutes), which is longer than the time cost originally estimated, which was 30 minutes.

In operation 410, detour anomaly detector 212 determines that a detour anomaly has occurred based on the accumulated time transgressing the time budget. In some examples, the accumulated time transgresses the time budget if the accumulated time is longer than the time budget. Conversely, the accumulated time does not transgress the time budget if the accumulated time is less than or equal to the time budget. For example, if the time budget allocated to the supply agent is 33 minutes but the accumulated time is 35 minutes, detour anomaly detector 212 would determine that a detour anomaly has occurred based on the trip taking longer than the time budget. If the accumulated time was only 29 minutes (e.g., only took the supply agent 14 minutes to reach the current location and the updated remaining time is 15 minutes), which is shorter than the time budget, the detour anomaly detector 212 determines that a detour anomaly is not detected.

In some examples, operation 408 is omitted. The detour anomaly detector 212 determines that a detour anomaly has occurred based on the updated remaining time and a remaining time budget, which is the time budget less the updated traveled time. For example, a time budget is set at 33 minutes. Assume that a supply agent spent 15 minutes to reach a current location, making traveled time 15 minutes and the remaining time budget 18 minutes (i.e., 33 minutes−15 minutes). The detour anomaly detector 212 determines that the detour anomaly has occurred if an updated remaining time (e.g., estimated at the current location) is longer than 18 minutes. In this way, calculating the accumulated time is optional.

In some examples, the time budget and the remaining times are calculated, or estimated, for each segment of the trip. The detour anomaly detector 212 determines that a detour anomaly has occurred based on a sum of the remaining time for each segment and the traveled time transgressing the time budget for each segment.

The technical benefits of utilizing a time-based approach for detour detection lie in its independence from the actual route taken by the supply agent. Without having to check if the supply agent has adhered to one or more predetermined routes, the detour anomaly detector 212 can operate based solely on temporal parameters. For example, a supply agent encounters real-world situations that necessitate deviations from the planned route, such as road closures, accidents, or unexpected congestion. A time-based approach allows for flexibility, as it does not penalize drivers for taking alternative paths as long as they remain within the time budget, thereby mitigating the likelihood of the detour anomaly detector 212 erroneously signaling a detour anomaly when the overall trip timing remains largely unaffected. By focusing on the time aspect, the progress engine 202 also avoids the complexity of analyzing route fidelity, which involves processing constant updates to the route data 136. This reduction in complexity leads to a more streamlined and robust system, conserving computational resources.

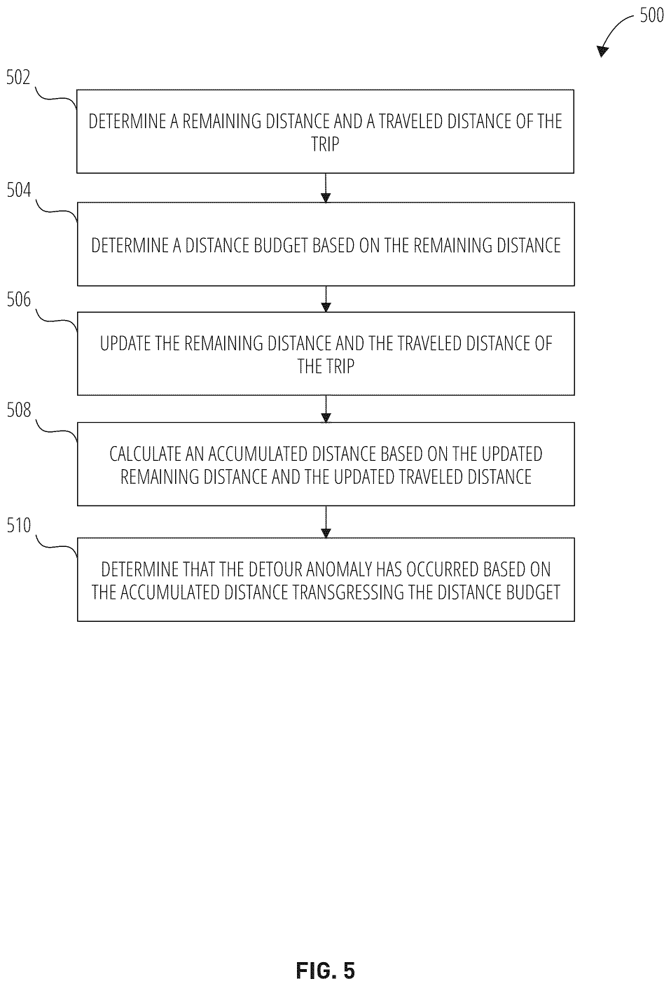

FIG. 5 is a flowchart illustrating a method 500 for detecting a detour anomaly based on distance metrics, according to some examples.

In operation 502, the computing system (e.g., via detour anomaly detector 212) updates a remaining distance and a traveled distance for a trip. Cost data 138, as shown in FIG. 1, can include a remaining distance to travel for a trip and a traveled distance for the trip and is updated in real-time or periodically based on the received GPS data. In some examples, the traveled distance represents the distance that the supply agent has covered since the start of the trip (e.g., the distance that the supply agent has already completed on the trip). For example, if a route for the trip includes two segments: the first segment extends from location A to location B, and the second segment extends from location B to location C. The distance of the first segment is 5 miles, while the distance of the second segment is 800 feet. At the start of the trip, when the supply agent is at location A, the remaining distance, or distance cost, for the first segment is 5 miles, and the remaining distance, or distance cost, for the second segment is 800 feet. At the commencement of the trip, the traveled distance is zero. As the trip progresses, the remaining distance of the trip is updated in real-time, taking into account the geographic locations of the supply agent and any route changes by the supply agent, and/or other relevant factors. In some examples, the route includes only one segment.

In operation 504, detour anomaly detector 212 establishes a distance budget based on the distance cost. The distance budget is an allocated distance that the supply agent covers to complete the trip. In some examples, detour anomaly detector 212 predicts that the supply agent is on a detour based on predicting that the supply agent will cover a distance greater than the distance budget to reach the target location. The distance budget acts as a threshold, and exceeding this threshold suggests a detour anomaly. In some examples, the distance budget is set to be a percentage greater than the initially determined distance cost. For example, if the distance budget is 10% more than the initially determined distance cost, a 50-kilometer distance cost would result in a distance budget of 55 kilometers (50 kilometers×110%). operation 504 for establishing a distance budget is excluded in some examples of method 500, and the newly updated remaining distance is directly compared with the remaining portion of the initially determined distance cost (e.g., initially determined remaining distance minus the traveled distance) to determine whether a detour anomaly has occurred.

In operation 506, detour anomaly detector 212 updates the remaining distance and the traveled distance of the trip as the trip progresses. In some examples, the cost module 120, shown in FIG. 1, updates cost data 138, including the remaining distances. The detour anomaly detector 212 accesses the updated remaining distances and the updated traveled distance of the trip. For instance, the supply agent aims to reach target location B from location A. At location A, the distance cost to reach location B is estimated to be 10 miles. When the supply agent reaches a current location, which is between location A and location B, the detour anomaly detector 212 accesses the updated remaining distance and the updated traveled distance of the trip. For example, the updated remaining distance is 6 miles and the updated traveled distance is 5 miles.

In operation 508, detour anomaly detector 212 calculates an accumulated distance based on the updated remaining distance and the updated traveled distance of the trip. The accumulated distance is the sum of the updated remaining distance and the updated traveled distance, expressed as accumulated distance=remaining distance+traveled distance. In the example provided above, the new estimated distance to complete the segment from location A to location B (e.g., accumulated distance) is 11 miles (e.g., 6 miles+5 miles), which is longer than the distance that was originally estimated distance cost, 10 miles.

In operation 510, detour anomaly detector 212 detects that a detour anomaly has occurred based on the accumulated distance transgressing the distance budget. In some examples, the accumulated distance transgresses the distance budget if the accumulated distance is longer than the distance budget. Conversely, the accumulated distance does not transgress the distance budget if the accumulated distance is shorter than or equal to the distance budget. For the example, if the distance budget is 11 miles but the accumulated distance is 12 miles (e.g., updated remaining distance+traveled distance), the detour anomaly detector 212 would determine that a detour anomaly has occurred based on the trip covering a greater distance than the distance budget. Conversely, if the accumulated distance was 10 miles (e.g., the supply agent has only covered 4 miles to reach the current location and the updated remaining distance is 6 miles), which is shorter than the distance budget, the detour anomaly detector 212 determines that no detour anomaly is detected.

In some examples, operation 508 is omitted. Instead, the detour anomaly detector 212 determines that a detour anomaly has occurred based on the updated remaining distance and a remaining distance budget, which is the distance budget less the updated traveled distance. For instance, if the distance budget is set at 11 miles, at a current location, the updated remaining distance is 8 miles, and the traveled distance is 5 miles, making the remaining distance budget 6 miles (e.g., 11 miles−5 miles). Detour anomaly detector 212 determines that the detour anomaly has occurred based on the updated remaining distance being greater than the remaining distance budget without having to calculate the accumulated distance.

In some examples, the distance budget and the remaining distance are calculated, or estimated, for each segment of the trip. The detour anomaly detector 212 determines that a detour anomaly has occurred based on a sum of the remaining distance for each segment and the traveled distance transgressing the time budget for each segment.

By utilizing a distance-based detour detection method, the detour anomaly detector 212 provides several technical benefits. First, detour anomaly detector 212 does not need to check if the supply agent has adhered to one or more predetermined routes to determine whether a detour anomaly has occurred. The detour anomaly detector 212 can operate based solely on distance-based metrics, enhancing adaptability to dynamic routing conditions. For example, if the supply agent finds a shortcut to the destination, the progress engine 202 performing this method would not treat this as a detour anomaly, reducing the likelihood of the detour anomaly detector 212 erroneously signaling a detour anomaly when the overall trip distance is unaffected or shortened. Utilizing this method also reduces computational load and increases process efficiency.

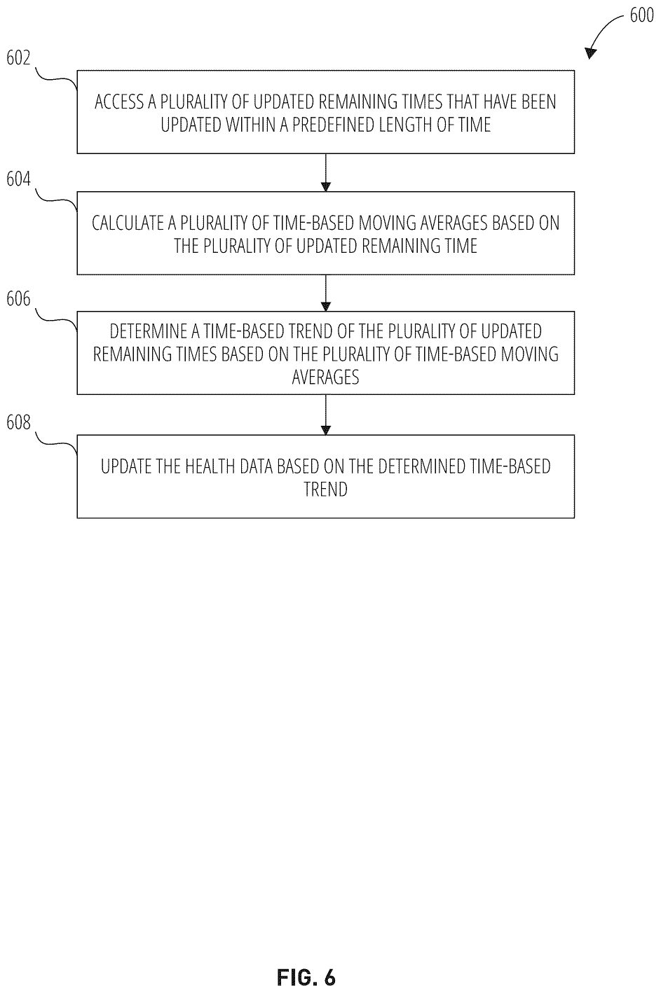

FIG. 6 is a flowchart illustrating a method 600 for determining detour anomaly recovery, according to some examples. Method 600 can be performed after a detour anomaly has been detected for the trip. The computing system (e.g., via progress engine 202) determines whether the trip has recovered from detour anomaly by analyzing the trends of a remaining time for the trip and/or remaining distances for a trip as time passes.

In operation 602, the computing system accesses cost data 138 that has been updated within a predefined length of time. For example, the cost data 138, shown in FIG. 1, comprises updated remaining times that have been calculated at various times throughout the trip. Using one minute as an example predefined length of time, the cost data 138 includes updated remaining times that were calculated within the one minute. As an example, in a predefined length of time of one minute, the updated remaining times include 20, 19, 17.5, 15, 11, 6, and 3 minutes.

In operation 604, the computing system calculates time-based moving averages based on the updated remaining times. In the example above, where the sequence of updated remaining times is 20, 19, 17.5, 15, 11, 6, and 3 minutes, the time-based moving averages are computed by averaging successive subsets of three entries (e.g., sliding window, subset window). The first average is derived by summing the first three updated remaining times (20, 19, 17.5) and dividing by three, yielding approximately 18.83 minutes. Subsequent averages are calculated by shifting the sliding window forward by one entry and repeating the process. The second average uses updated remaining times 19, 17.5, and 15, resulting in approximately 17.17 minutes. The third average uses 17.5, 15, and 11, resulting in 14.5 minutes, and so on. This sliding window approach continues until all sets of three consecutive entries have been averaged. It should be noted that while this example uses sets of three for simplicity, the method is not constrained to this number; sets of four, five, six, or any other number can be used to calculate the moving averages, depending on the desired granularity and sensitivity of the analysis.

In operation 606, the computing system determines a time-based trend of the updated remaining times based on the time-based moving averages. The time-based trend is either an increasing trend, a decreasing trend, or a stable trend. The computing system analyzes the time-based moving averages to discern whether there is a consistent increase or decrease in the updated remaining time over the predefined length of time. In some examples, an increasing trend is characterized by subsequent moving averages being higher than those calculated previously. Conversely, a decreasing trend is characterized by subsequent moving averages being lower than those calculated earlier. A stable trend refers to patterns that do not exhibit characteristics of either increasing or decreasing trends. A decreasing trend in the time-based moving averages signifies that the supply agent is making progress in the trip. Conversely, either an increasing trend or stable trend in the time-based moving averages suggests a lack of progress in the trip; hence, the health status of the trip is not improving.

In operation 608, the computing system determines the health data based on the determined time-based trend. For example, if the computing system determines that a decreasing trend exists in time-based moving averages, progress engine 202 marks the trip as either healthy or recovered.

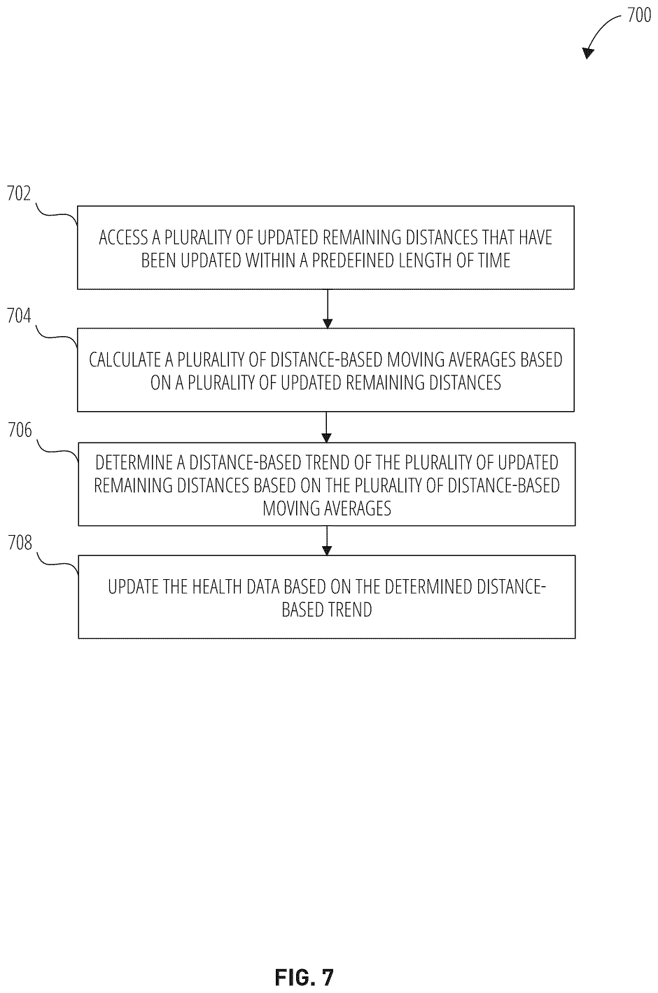

FIG. 7 is a flowchart illustrating a method 700 for determining detour anomaly recovery, according to some examples. Method 700 can be performed after a detour anomaly has been detected for the trip. The computing system (e.g., via progress engine 202) determines whether the trip has recovered from detour anomaly by analyzing the trends of a remaining time for the trip and/or remaining distances for a trip as time passes.

In operation 702, computing system accesses cost data 138 that has been updated within a predefined length of time. For example, the cost data 138, shown in FIG. 1, comprises updated remaining distances at various times throughout the trip. The updated remaining distances is used to analyze trends for the trip. In some examples, the predefined length of time is one minute for updating remaining distances. Within this one-minute window, the cost data 138 includes remaining distances. For example, in the predefined length of time of one minute, the updated remaining distances are 100, 95, 85, 70, 50, 30, and 10 kilometers.

In operation 704, the computing system calculates distance-based moving averages based on the updated remaining distances. The cost data 138 updated within the predefined length of time also includes updated remaining distances. Using an example where the predefined length of time is one minute, within this one-minute window, the cost data 138 includes seven entries of updated remaining distances: 100, 95, 85, 70, 50, 30, and 10 kilometers. Note that the predefined length of time can be different from the predefined length of time used in the time-based analysis. Using the example provided above, the distance-based moving averages are computed as follows. First, the initial moving average for the remaining distances is calculated by averaging the first three values (100, 95, 85), resulting in approximately 93.33 kilometers. The subsequent moving average is obtained by averaging the next set of three values (95, 85, 70), which approximates to 83.33 kilometers. The process continues with the third set (85, 70, 50), yielding an average of approximately 68.33 kilometers. This method mirrors the approach used for calculating the time-based moving averages for the time-based analysis, where each average is computed from three adjacent entries before the window advances to incorporate the subsequent entry in the sequence. This sliding window approach continues until all sets of three consecutive entries have been averaged. It should be noted that while this example uses sets of three for simplicity, the method is not constrained to this number; sets of four, five, six, or any other number can be used to calculate the moving averages, depending on the desired granularity and sensitivity of the analysis.

In operation 706, the computing system determines a distance-based trend based on the distance-based moving averages. This distance-based trend analysis focuses on the distance data and, like the time-based trend, can be either increasing, decreasing, or stable. The computing system examines the distance-based moving averages to ascertain whether there is a consistent reduction in the updated distances remaining over the predefined length of time. A decreasing trend in these distance-based moving averages indicates that the trip is physically progressing toward its destination as expected. Conversely, either an increasing trend or a stable trend in these distance-based moving averages indicates that the health status of the trip is not improving.

In operation 708, the computing system determines the health data based on the distance-based trend. If a decreasing trend is observed in the second moving averages, progress engine 202 confirms the trip as either healthy or recovered.

In some examples, the computing system determines whether the health data has recovered by determining either exclusively the time-based trend or exclusively the distance-based trend because either trend alone is capable of indicating whether the trip has recovered from detour anomaly.

Alternatively, the computing system updates the health data from unhealthy to healthy or recovered based on determining that both the time-based trend and the distance-based trend are decreasing. This dual-trend analysis provides a more comprehensive view of the health status of the trip, considering both temporal and spatial progress. The convergence of decreasing trends in both time and distance is a strong indicator that any previously identified anomalies have been resolved, and the trip is now on track to reach its destination within the expected parameters.

In some examples, method 700 is performed by the computing system via either the detour anomaly detector 212 and/or the health manager 218. For example, the detour anomaly detector 212 determines that the detour anomaly no longer exists, and the health manager 218 determines that the health status of the trip has recovered. Optionally, in response to determining that the trip has recovered, the health manager 218 outputs the updated health status so that streaming computing devices 220 receive the updated health status in a timely manner.

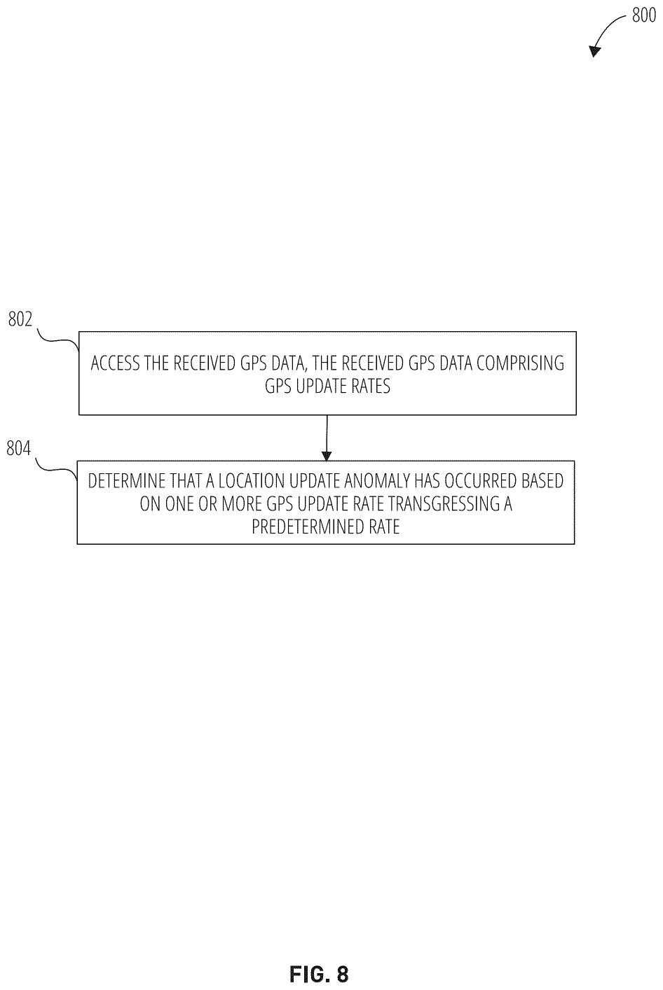

FIG. 8 is a flowchart illustrating a method 800 for detecting a location update anomaly, according to some examples.

In operation 802, the computing system (e.g., via progress engine 202) analyzes GPS update rates included in the received GPS data collected from the consumer device 104 and/or provider devices 106. A GPS update rate refers to the frequency at which GPS data is being received from the consumer device 104 and/or provider device 106. In some examples, the GPS update rate is calculated based on the number of GPS data points received within a specified period of time. In some other examples, the GPS update rate is determined by analyzing the timestamps of GPS data to assess the regularity and intervals of the location updates provided by the GPS hardware.

In operation 804, the computing system determines that a location update anomaly has occurred based on one or more GPS update rates transgressing a predetermined rate (e.g., 1 Hz, 0.25 Hz). In some examples, the computing system compares the one or more GPS update rates to the predetermined rate. If the one or more GPS update rates are lower than the predetermined rate, the computing system determines that a location update anomaly has occurred. In some other examples, the computing system identifies a location update anomaly in response to determining that more than one GPS update rate is lower than the predetermined rate.

In some examples, detecting a location update anomaly is expanded to include a calibration step where the system learns the typical GPS update rates across various environments. This step would enable the establishment of context-aware anomaly thresholds, thereby reducing the likelihood of false positives. Additionally, the computing system can assess the GPS signal's quality, considering factors such as signal strength and integrity, which are indicative of the reliability of the location updates.

In some examples, the location update anomaly detector 206 integrates machine learning algorithms to enhance the location update anomaly detector's predictive capabilities by analyzing historical GPS data patterns and GPS update rate to forecast potential anomalies. Furthermore, corroborating GPS data with auxiliary data sources, such as cellular or Wi-Fi signals, could validate the GPS update rate and/or the occurrence of the location update anomaly.

In some examples the anomaly detection logic is adaptive, adjusting its sensitivity based on the service consumer's and/or supply agent's speed. For example, a stationary supply agent has less frequent location updates, and a static threshold does not accurately reflect the state of the GPS signal under such conditions. By incorporating these enhancements, the location update anomaly detector 206 is more robust, accurate, and capable of providing actionable insights to maintain the efficacy of the progress engine 202's location tracking.

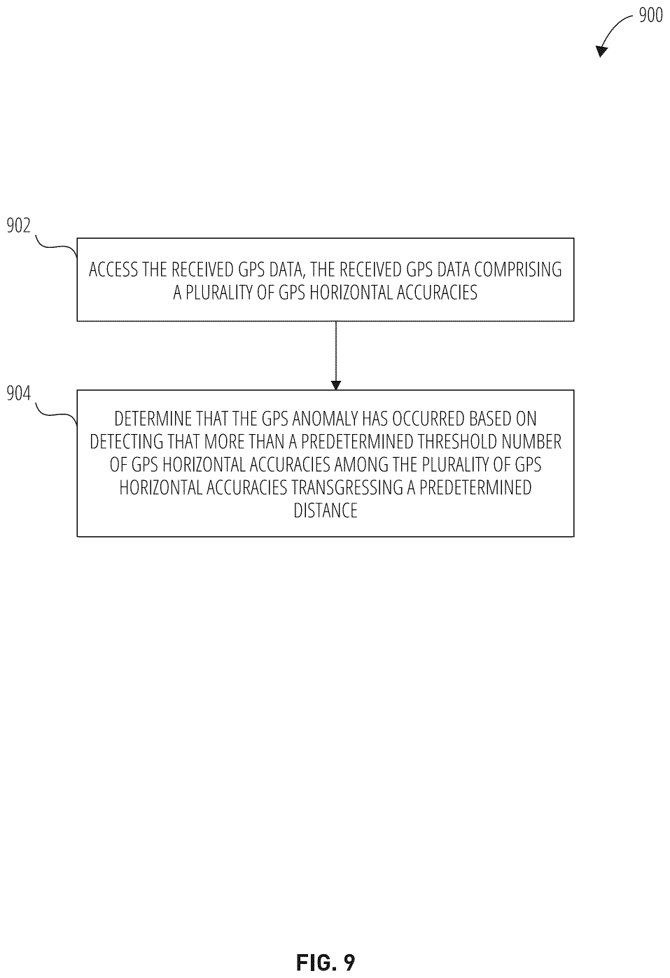

FIG. 9 is a flowchart illustrating a method 900 for detecting a GPS anomaly, according to some examples.

In operation 902, the computing system (e.g., via progress engine 202) analyzes the received GPS data collected from the consumer device 104 and/or provider device 106 to determine GPS horizontal accuracies. As explained above, GPS data 134 includes a plurality of GPS horizontal accuracies. A GPS horizontal accuracy refers to the degree of precision of GPS data in terms of its ability to correctly identify its horizontal position on the Earth's surface. It is typically measured as a radius in meters, indicating the confidence level that the actual location of the GPS hardware is within this radius of the reported coordinates. The smaller the radius, the higher the accuracy and the greater the likelihood that the GPS position is close to the GPS hardware's actual location. Horizontal accuracy is influenced by various factors, including satellite geometry, signal blockage, atmospheric conditions, and the quality of the receiver of the GPS hardware.

In operation 904, the computing system determines that the GPS anomaly has occurred based on detecting that more than a predetermined threshold number of GPS horizontal accuracies among the plurality of GPS horizontal accuracies transgressing a predetermined distance. The Progress Engine 202 accesses and analyzes the plurality of GPS horizontal accuracies. In some examples, a GPS horizontal accuracy (e.g., 61 meters) transgressing a predetermined distance (e.g., 50 meters) is considered inaccurate. If a number of these GPS horizontal accuracies exceeds a predetermined threshold (e.g., 3), the GPS anomaly determines that the GPS anomaly has occurred. In other words, if the predetermined threshold is 3 and the predetermined distance is 50 meters, the GPS anomaly detector 208 would determine that a GPS anomaly has occurred if the computing system detects more than three GPS horizontal accuracies that are over 50 meters.

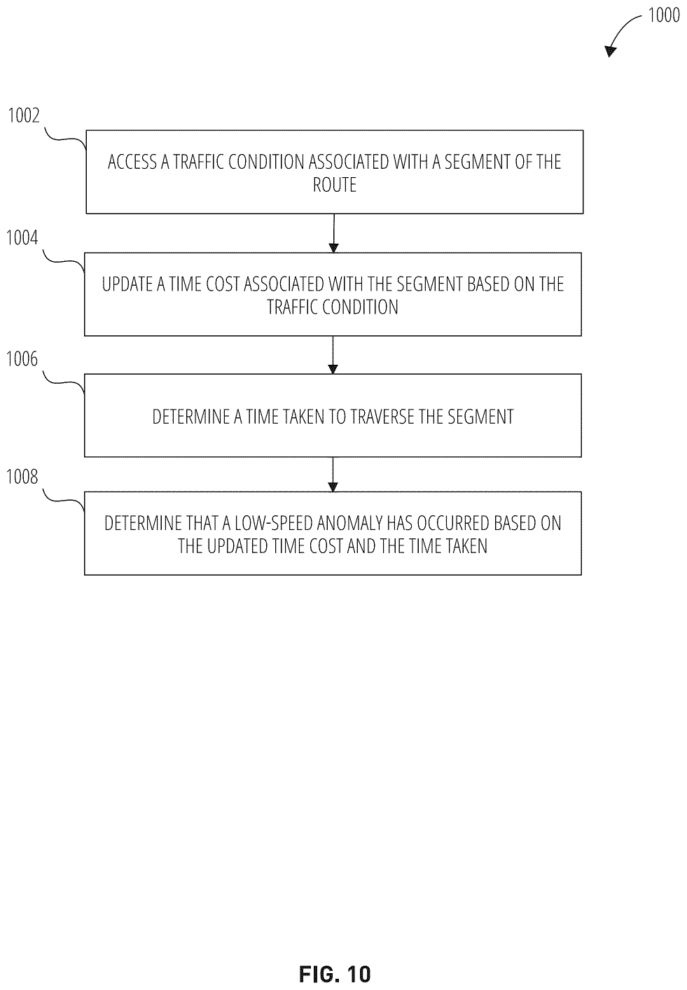

FIG. 10 is a flowchart illustrating a method 1000 for detecting a low-speed anomaly, according to some examples.

In operation 1002, the computing system (e.g., via progress engine 202) accesses traffic condition data for one or more segments of the route for the trip. The traffic condition data comprises data such as real-time traffic flow information, congestion levels, road closures, or any other relevant traffic-related information that could impact travel time.

In operation 1004, the computing system updates the time cost and/or remaining times of the cost data 138 for traversing the one or more segments of the route based on the traffic condition data. The updated time cost reflects the expected duration to travel the segment(s) under the current traffic conditions.

In operation 1006, the computing system measures the time taken by the supply agent to traverse the segment in question.

In operation 1008, the computing system performs a comparison between the time taken and the updated cost data (e.g., updated time cost, updated remaining time). If the time taken exceeds the updated cost data, indicating that the vehicle is moving slower than expected given the traffic conditions, progress engine 202 determines that a low-speed anomaly has occurred.

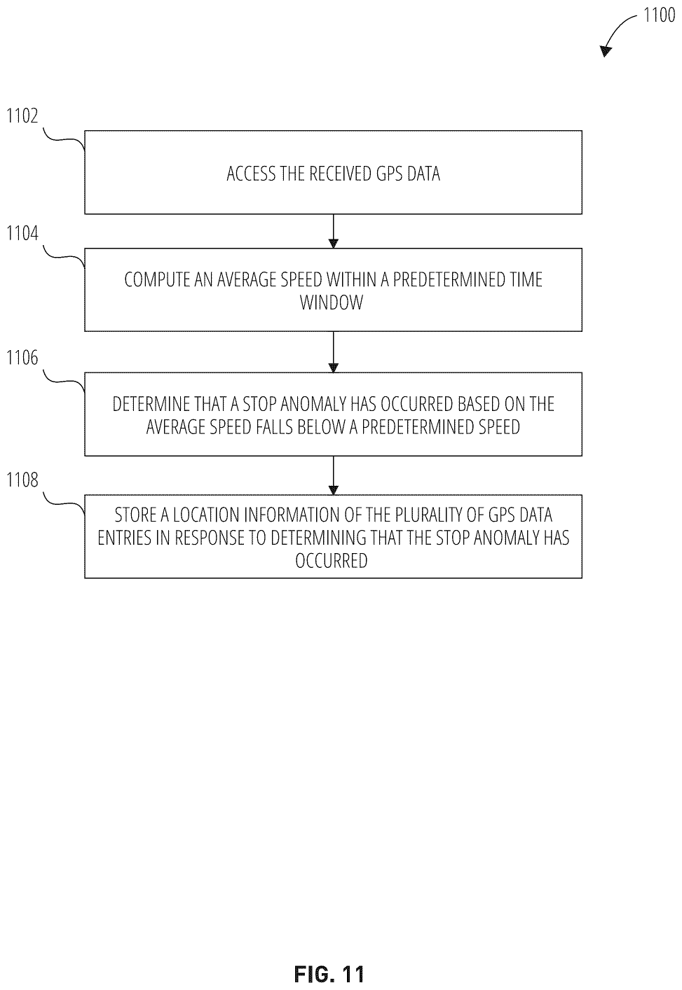

FIG. 11 is a flowchart illustrating a method 1100 for detecting a stop anomaly, according to some examples.

In operation 1102, the computing system (e.g., via stop anomaly detector 214) accesses updated GPS data 134. As explained above, updated GPS data 134 includes the service consumer's and/or supply agent's geographic location and timestamps associated with the geographic locations, which is used to track the service consumer's and the supply agent's movement over time.

In some examples, in response to accessing the updated GPS data 134, the stop anomaly detector 214 accesses the place database 128 to identify legitimate stopping locations near the supply agent's geographic locations. Legitimate stopping locations are locations where it is reasonable for supply agents to stop during a trip. Examples of legitimate stopping locations include a trip's destination, a pick-up location for a service consumer or an item for delivery, fuel stations for refueling, charging stations for electric vehicles, or areas with restroom facilities. In some examples, the computing system skips operations 1104-1108 and restarts method 1100 by proceeding to operation 1102 in response to identifying that the supply agent is stopped at one of the legitimate stopping locations. This exception handling ensures that routine and explainable stops do not trigger false positives, a change in the health data, or false anomaly detection, thereby focusing on unexpected stops that require intervention or further investigation.

In operation 1104, the computing system calculates the average speed of the supply agent within a predetermined time window (e.g., one minute). In some examples, the average speed is calculated based on the geographic locations included in the updated GPS data and the predetermined time window. In other words, the computing system calculates the average speed based on the distance covered within the predetermined time window and the duration of the predetermined time window. Alternatively, the computing system determines the average speed based on the speed data included in the updated GPS data 134. For example, if within a one-minute predetermined time window, the computing system receives 15 entries of updated GPS data 134, each comprising a speed associated with the service consumer and/or the supply agent, and the computing system calculates an average speed using the 15 entries of received updated GPS data 134.

In operation 1106, the computing system compares the calculated average speed with a predetermined speed threshold. If the average speed falls below the predetermined speed, indicating that the service consumer's and/or supply agent's movement has slowed to the point of being considered a stop, the computing system determines that a stop anomaly has occurred. Alternatively, the computing system skips operation 1104 and detect that a stop anomaly has occurred if there is a negligible change (e.g., the change in geographic locations being smaller than a certain threshold) in the service consumer's and/or supply agent's geographic locations within the predetermined time window. In some examples, non-negligible changes in geographic locations are the ones that exceed a predetermined distance (e.g., GPS horizontal accuracy).

In some examples, the stop anomaly detector 214 identifies a stop anomaly based on the activity data 224. For example, in response to detecting that a supply agent is in a first modality (e.g., idling) based on the activity data 224 but the supply agent is expected to be in a second modality (e.g., driving), the detour anomaly detector 212 flags a stop anomaly. In some other examples, in response to detecting that the supply agent is idle based on the activity data 224 but the supply agent is near a legitimate stopping location, the stop anomaly detector 214 would not flag a stop anomaly.

Optionally, in operation 1108, the computing system stores the geographic location from the received GPS data in response to determining that the stop anomaly has occurred. The stored geographic location can be used for further analysis or to provide insights into the service consumer's and/or supply agent's behavior and route compliance.

In some examples, the progress engine 202 enhances its ability to manage anomalies by detecting and responding to situations where a driver's modality does not match the expected behavior for a given segment of the trip. For example, the progress engine 202 includes an anomaly detector (e.g., stop anomaly detector) configured to identify when a driver, who should be operating a vehicle, is instead detected to be walking. This example may occur when the driver leaves the vehicle to walk for an extended period during what should be an active driving segment. In response to detecting such an anomaly, the progress engine 202 further analyzes the situation by comparing the driver's current modality, derived from activity data 224, against the expected modality for that segment of the route. The activity data 224 includes movement modality information such as driving, walking, running, idling, or bicycling, which is processed by an activity recognition pre-processor 204 of the progress engine. In some examples, if the progress engine confirms that the driver's modality is indeed inconsistent with the expected driving activity, the progress engine triggers a response protocol. This protocol may involve: sending a real-time alert to the driver to investigate the reason for the deviation, adjusting the route dynamically if the situation warrants such an action, for example, if the driver had to park far from a delivery location and proceed on foot, and logging the incident for further analysis to improve future route planning and anomaly detection algorithms.

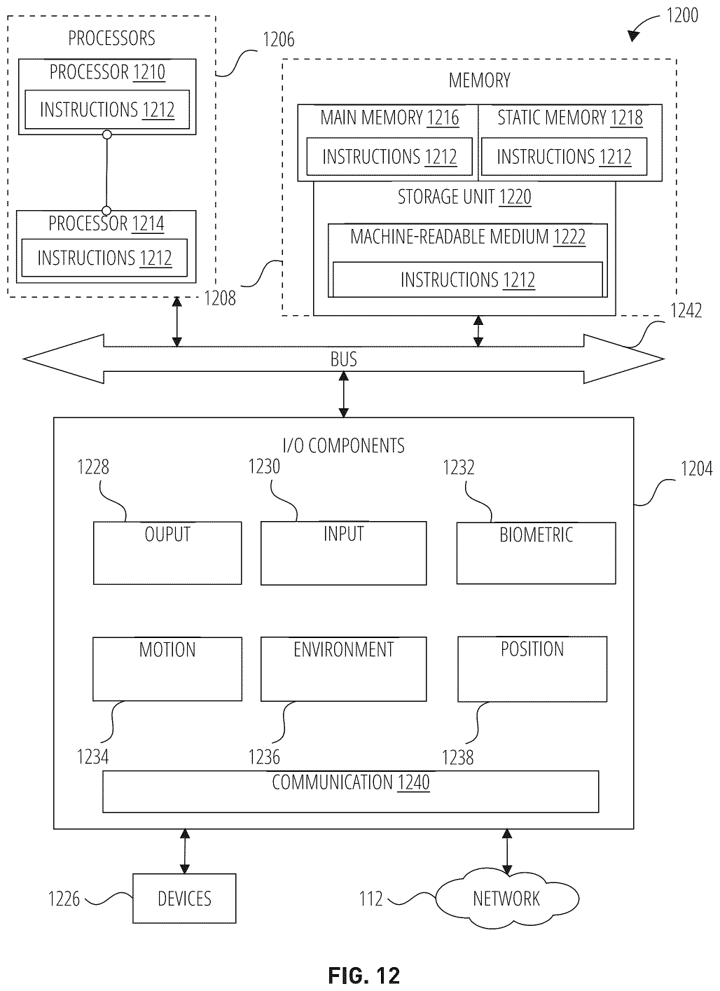

FIG. 12 is a diagrammatic representation of the machine 1200 within which instructions 1212 (e.g., software, a program, an application, an applet, an app, or other executable code) for causing the machine 1200 to perform any one or more of the methodologies discussed herein may be executed. For example, the instructions 1212 may cause the machine 1200 to execute any one or more of the methods described herein. The instructions 1212 transform the general, non-programmed machine 1200 into a particular machine 1200 programmed to carry out the described and illustrated functions in the manner described. The machine 1200 may operate as a standalone device or be coupled (e.g., networked) to other machines. In a networked deployment, the machine 1200 may operate in the capacity of a server machine or a client machine in a server-client network environment, or as a peer machine in a peer-to-peer (or distributed) network environment. The machine 1200 may comprise, but not be limited to, a server computer, a client computer, a personal computer (PC), a tablet computer, a laptop computer, a netbook, a set-top box (STB), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1212, sequentially or otherwise, that specify actions to be taken by the machine 1200. Further, while a single machine 1200 is illustrated, the term “machine” may include a collection of machines that individually or jointly execute the instructions 1212 to perform any one or more of the methodologies discussed herein. In some examples, the computing system is a machine 1200.

The machine 1200 may include processors 1206, memory 1208, and I/O components 1204, which may be configured to communicate via a bus 1242. In some examples, the processors 1206 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application-Specific Integrated Circuit (ASIC), a Radio-Frequency Integrated Circuit (RFIC), another Processor, or any suitable combination thereof) may include, for example, a Processor 1210 and a Processor 1214 that execute the instructions 1212. The term “Processor” is intended to include multi-core processors that may comprise two or more independent processors (sometimes referred to as “cores”) that may execute instructions contemporaneously. Although FIG. 12 shows multiple processors, the machine 1200 may include a single processor with a single core, a single processor with multiple cores (e.g., a multi-core processor), multiple processors with a single core, multiple processors with multiples cores, or any combination thereof.

The memory 1208 includes a main memory 1216, a static memory 1218, and a storage unit 1220, both accessible to the processors 1206 via the bus 1242. The main memory 1216, the static memory 1218, and storage unit 1220 store the instructions 1212 embodying any one or more of the methodologies or functions described herein. The instructions 1212 may also reside, wholly or partially, within the main memory 1216, within the static memory 1218, within a non-transitory computer-readable storage medium (e.g., a non-transitory machine-readable medium 1222) within the storage unit 1220, within the processors 1206 (e.g., within the processor's cache memory), or any suitable combination thereof, during execution thereof by the machine 1200.

The I/O components 1204 may include various components to receive input, provide output, produce output, transmit information, exchange information, or capture measurements. The specific I/O components 1204 included in a particular machine depend on the type of machine. For example, portable machines such as mobile phones may include a touch input device or other such input mechanisms, while a headless server machine will likely not include such a touch input device. The I/O components 1204 may include many other components not shown in FIG. 12. In various examples, the I/O components 1204 may include output components 1228 and input components 1230. The output components 1228 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), or other signal generators. The input components 1230 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further examples, the I/O components 1204 may include biometric components 1232, motion components 1234, environmental components 1236, or position components 1238, among a wide array of other components. For example, the biometric components 1232 include components to detect expressions (e.g., hand expressions, facial expressions, vocal expressions, body gestures, or eye-tracking), measure biosignals (e.g., blood pressure, heart rate, body temperature, perspiration, or brain waves), or identify a person (e.g., voice identification, retinal identification, facial identification, fingerprint identification, or electroencephalogram-based identification). The motion components 1234 include acceleration sensor components (e.g., accelerometer), gravitation sensor components, rotation sensor components (e.g., gyroscope). The environmental components 1236 include, for example, one or cameras, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1238 include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1204 further include communication components 1240 operable to couple the machine 1200 to a network 112 or devices 1226 via respective coupling or connections. For example, the communication components 1240 may include a network interface component or another suitable device to interface with the network 112. In further examples, the communication components 1240 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1226 may be another machine, or any of a wide variety of peripheral devices (e.g., a peripheral device coupled via a USB).

Moreover, the communication components 1240 may detect identifiers or include components operable to detect identifiers. For example, the communication components 1240 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Data glyph, Maxi Code, PDF417, Ultra Code, UCC RSS-2D bar code, and other optical codes), or acoustic detection components (e.g., microphones to identify tagged audio signals). In addition, a variety of information may be derived via the communication components 1240, such as location via Internet Protocol (IP) geolocation, location via Wi-Fi® signal triangulation, or location via detecting an NFC beacon signal that may indicate a particular location.

The various memories (e.g., main memory 1216, static memory 1218, and/or memory of the processors 1206) and/or storage unit 1220 may store one or more sets of instructions and data structures (e.g., software) embodying or used by any one or more of the methodologies or functions described herein. These instructions (e.g., the instructions 1212), when executed by processors 1206, cause various operations to implement the disclosed examples.

The instructions 1212 may be transmitted or received over the network 112, using a transmission medium, via a network interface device (e.g., a network interface component included in the communication components 1240) and using any one of several well-known transfer protocols (e.g., hypertext transfer protocol (HTTP)). Similarly, the instructions 1212 may be transmitted or received using a transmission medium via a coupling (e.g., a peer-to-peer coupling) to the devices 1226.

In some examples, the mobility network servers 102, consumer device 104, and provider device 106 comprise one or more machines 1200.

While the present subject matter has been described in detail with respect to specific example embodiments and methods thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

Throughout this description, the embodiment and examples shown should be considered as exemplars, rather than as limitations on the present invention. As used herein, the words “example,” “exemplary,” and “illustrative” mean serving as an example, instance, or illustration. Any implementation described herein as “example,” “exemplary,” or “illustrative” is not necessarily to be construed as preferred or advantageous over other implementations. Moreover, the terms “embodiments of the invention,” “embodiments,” or “invention” do not require that all embodiments of the invention include the discussed feature, advantage, or mode of operation.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

What is claimed is:

1. A method, comprising:
receiving, in real-time, Global Positioning System (GPS) data from a plurality of devices, each of the plurality of devices corresponding to a supply agent executing a respective route for a respective trip;
analyzing, by each anomaly detector of a set of anomaly detectors, the received GPS data to generate an output associated with a respective anomaly detector and the respective trip;
generating an updated a health status for each trip using the output from each anomaly detector;
determining that the updated health status for a first trip triggers a notification; and
providing the notification associated with the updated health status for the first trip.

2. The method of claim 1, wherein one anomaly detector of the set of anomaly detectors comprises a detour anomaly detector, and analyzing the received GPS data to generate the output associated with the detour anomaly detector comprises:
determining, based on the GPS data, a remaining time to traverse the respective route that has not been covered by the supply agent and a traveled time that the supply agent has already incurred on the first trip;
detecting that a detour anomaly has occurred based on a sum of the remaining time and the traveled time transgressing a time budget set for the first trip; and
generating the output associated with the detour anomaly to indicate that a detour anomaly has occurred.

3. The method of claim 2, further comprising:
accessing one or more updated remaining times that have been updated within a predefined length of time;
determining a trend of the one or more updated remaining times based on a plurality of time-based moving averages of the one or more updated remaining times; and
based on determining that the trend is a decreasing trend, updating the health status for the first trip to indicate that the first trip has recovered from the detour anomaly.

4. The method of claim 1, wherein one anomaly detector of the set of anomaly detectors comprises a detour anomaly, and analyzing the received GPS data to generate the output associated with the detour anomaly comprises:
updating a remaining distance to traverse the respective route that has not been covered by the supply agent based on the received GPS data and a traveled distance that the supply agent has already completed on the first trip;
detecting that a detour anomaly has occurred based on a sum of the remaining distance and the traveled distance transgressing a distance budget set for the first trip; and
generating the output associated with the detour anomaly to indicate that a detour anomaly has occurred.

5. The method of claim 4, further comprising:
accessing one or more updated remaining distances that have been updated within a predefined length of time;
determining a trend of the one or more updated remaining distances based on a plurality of distance-based moving averages of the one or more updated remaining distances; and
based on determining that the trend is a decreasing trend, updating the health status for the first trip to indicate that the first trip has recovered from the detour anomaly.

6. The method of claim 1, wherein the received GPS data comprises a GPS update rate, one anomaly detector of the set of anomaly detectors corresponds to a lack of location update anomaly, and analyzing the received GPS data to generate the output associated with the lack of location update anomaly comprises:
detecting that the lack of location update anomaly has occurred based on the GPS update rate transgressing a predetermined rate; and
generating the output associated with the lack of location update anomaly to indicate that the lack of location update anomaly has occurred.

7. The method of claim 1, the received GPS data comprises a GPS horizontal accuracy, one anomaly detector of the set of anomaly detectors corresponds to a GPS anomaly, and analyzing the received GPS data to generate the output associated with the GPS anomaly comprises:
detecting that the GPS anomaly has occurred based on detecting that more than a predetermined threshold number of GPS horizontal accuracies among a plurality of received GPS horizontal accuracies transgressing a predetermined distance; and
generating the output associated with the GPS anomaly to indicate that the GPS anomaly has occurred.

8. The method of claim 1, wherein one anomaly detector of the set of anomaly detectors corresponds to a low-speed anomaly, and analyzing the received GPS data to generate the output associated with the low-speed anomaly comprises:
accessing a traffic condition associated with a segment of the respective route;
estimating a remaining time to traverse the segment based on the traffic condition;
determining an actual traversal time for traversing the segment;
detecting that the low-speed anomaly has occurred based on the actual traversal time being longer than the estimated remaining time; and
generating the output associated with the low-speed anomaly to indicate that the low-speed anomaly has occurred.

9. The method of claim 1, wherein one anomaly detector of the set of anomaly detectors corresponds to a stop anomaly, and analyzing the received GPS data to generate the output associated with the stop anomaly comprises:
computing an average speed associated with the supply agent within a predetermined time window based on the received GPS data;
detecting that the stop anomaly has occurred based on the average speed falling below a predetermined speed; and
generating the output associated with the stop anomaly to indicate that the stop anomaly has occurred.

10. The method of claim 1, wherein updating the health status for the first trip using the outputs from the set of anomaly detectors further comprises:
generating a confidence score for each output from the set of anomaly detectors; and
updating the health status for the first trip based on the outputs from the set of anomaly detectors and the generated confidence scores.

11. A computing system comprising:
at least one processor; and
at least one memory storing instructions that, when executed by the at least one processor, configure the computing system to perform operations comprising:
receiving, in real-time, Global Positioning System (GPS) data from a plurality of devices, each of the plurality of devices corresponding to a supply agent executing a respective route for a respective trip;
analyzing, by each anomaly detector of a set of anomaly detectors, the received GPS data to generate an output associated with a respective anomaly detector and the respective trip;
generating an updated a health status for each trip using the output from each anomaly detector;
determining that the updated health status for a first trip triggers a notification; and
providing the notification associated with the updated health status for the first trip.

12. The computing system of claim 11, wherein one anomaly detector of the set of anomaly detectors comprises a detour anomaly detector, and analyzing the received GPS data to generate the output associated with the detour anomaly detector comprises:
determining, based on the GPS data, a remaining time to traverse the respective route that has not been covered by the supply agent and a traveled time that the supply agent has already incurred on the first trip;
detecting that a detour anomaly has occurred based on a sum of the remaining time and the traveled time transgressing a time budget set for the first trip; and
generating the output associated with the detour anomaly to indicate that a detour anomaly has occurred.

13. The computing system of claim 12, wherein the operations further comprise:
accessing one or more updated remaining times that have been updated within a predefined length of time;
determining a trend of the one or more updated remaining times based on a plurality of time-based moving averages of the one or more updated remaining times; and
based on determining that the trend is a decreasing trend, updating the health status for the first trip to indicate that the first trip has recovered from the detour anomaly.

14. The computing system of claim 11, wherein one anomaly detector of the set of anomaly detectors comprises a detour anomaly, and analyzing the received GPS data to generate the output associated with the detour anomaly comprises:
updating a remaining distance to traverse the respective route that has not been covered by the supply agent based on the received GPS data and a traveled distance that the supply agent has already completed on the first trip;
detecting that a detour anomaly has occurred based on a sum of the remaining distance and the traveled distance transgressing a distance budget set for the first trip; and
generating the output associated with the detour anomaly to indicate that a detour anomaly has occurred.

15. The computing system of claim 14, wherein the operations further comprise:
accessing one or more updated remaining distances that have been updated within a predefined length of time;
determining a trend of the one or more updated remaining distances based on a plurality of distance-based moving averages of the one or more updated remaining distances; and
based on determining that the trend is a decreasing trend, updating the health status for the first trip to indicate that the first trip has recovered from the detour anomaly.

16. The computing system of claim 11, wherein the received GPS data comprises a GPS update rate, one anomaly detector of the set of anomaly detectors corresponds to a lack of location update anomaly, and analyzing the received GPS data to generate the output associated with the lack of location update anomaly comprises:
detecting that the lack of location update anomaly has occurred based on the GPS update rate transgressing a predetermined rate; and
generating the output associated with the lack of location update anomaly to indicate that the lack of location update anomaly has occurred.

17. The computing system of claim 11, the received GPS data comprises a GPS horizontal accuracy, one anomaly detector of the set of anomaly detectors corresponds to a GPS anomaly, and analyzing the received GPS data to generate the output associated with the GPS anomaly comprises:
detecting that the GPS anomaly has occurred based on detecting that more than a predetermined threshold number of GPS horizontal accuracies among a plurality of received GPS horizontal accuracies transgressing a predetermined distance; and
generating the output associated with the GPS anomaly to indicate that the GPS anomaly has occurred.

18. The computing system of claim 11, wherein one anomaly detector of the set of anomaly detectors corresponds to a low-speed anomaly, and analyzing the received GPS data to generate the output associated with the low-speed anomaly comprises:
accessing a traffic condition associated with a segment of the respective route;
estimating a remaining time to traverse the segment based on the traffic condition;
determining an actual traversal time for traversing the segment;
detecting that the low-speed anomaly has occurred based on the actual traversal time being longer than the estimated remaining time; and
generating the output associated with the low-speed anomaly to indicate that the low-speed anomaly has occurred.

19. The computing system of claim 11, wherein one anomaly detector of the set of anomaly detectors corresponds to a stop anomaly, and analyzing the received GPS data to generate the output associated with the stop anomaly comprises:
computing an average speed associated with the supply agent within a predetermined time window based on the received GPS data;
detecting that the stop anomaly has occurred based on the average speed falling below a predetermined speed; and
generating the output associated with the stop anomaly to indicate that the stop anomaly has occurred.

20. A non-transitory computer-readable storage medium, the non-transitory computer-readable storage medium including instructions that when executed by at least one computer, cause the at least one computer to perform operations comprising:
receiving, in real-time, Global Positioning System (GPS) data from a plurality of devices, each of the plurality of devices corresponding to a supply agent executing a respective route for a respective trip;
analyzing, by each anomaly detector of a set of anomaly detectors, the received GPS data to generate an output associated with a respective anomaly detector and the respective trip;
generating an updated health status for each trip using the output from each anomaly detector;
determining that the updated health status for a first trip triggers a notification; and
providing the notification associated with the updated health status for the first trip.
